(19) United States
(12) Patent Application Publication
(10) Pub. No.: US 2002/0170358 A1
(43) Pub. Date: Nov. 21, 2002

(54) Method of testing a panel-like workpiece

(76) Inventor: Ralf Schackel, Everode (DE)

Correspondence Address: Gary A. Hecht, Synnestvedt & Lechner LLP, 1101 Market St., Philadelphia, PA, 19107-2950, US

(21) Appl. No.: 10/150,296

(22) Filed: May 17, 2002

(30) Foreign Application Priority Data
May 18, 2001 (DE) 101 24 689.7

(51) Int. Cl. G01N 9/24; G01N 29/04

(52) U.S. Cl. 73/596; 73/602

(57) ABSTRACT

During testing of a panel-like workpiece by means of ultrasonic penetration and at least one inspection channel comprising an ultrasonic transmitter and an ultrasonic receiver on opposite-lying sides of the workpiece, diverse test signals and test information are accumulated at the ultrasonic receiver. Each ultrasonic receiver is connected to an evaluation system, in which the test signals and the test information are combined, evaluated and reduced to a single piece of result-information which describes the tested workpiece. If at least two inspection channels are provided, it can also be provided that a reduction to a single piece of result-information is performed in each case for each ultrasonic receiver.

The invention relates to a method according to the preamble of claim 1 and to a method according to the preamble of claim 2.

Known ultrasonic measuring methods for panel-like workpieces which operate according to the ultrasonic penetration method produce a large quantity of information from the measuring procedure for a specific part of the workpiece. This information is made available optically and/or acoustically in the most varied manner to the operator of this type of measuring system. Using this large quantity of information, the operator has to make decisions relating to the further mode of production. This requires a considerable amount of experience in the production procedure and the panel-like workpiece produced, in order to be able to make a correct decision. This type of generic method is disclosed, for example, in DE 94 02 199 U1.

U.S. Pat. No. 3,813,926 describes a method, in which by the reflection of pulsed, acoustic signals an adhesive layer of a composite material structure is tested for any possible defective points. The intensity of the reflection is evaluated, wherein a sum of several consecutive pulses is produced. However, it is not possible to generate signals or information of a fundamentally different type or to evaluate them in such a manner that they are reduced to a single piece of result-information.

It is the object of the invention to make it easier for the operator to assess accurately the production situation at any given time.

This object is achieved by the features of claim 1. The operator is no longer provided with a large quantity of information but rather only a single piece of result-information which is compressed and reduced from the numerous measurement values. This can be performed, for example, by a pointer which according to the tachometer needle moves along a scale including the result-information in a series of values.

In accordance with claim 3, this result-information can represent a characteristic number of quality in each case. For example, it is possible in this manner for the operator to view the aforementioned scale to see whether or not his/her production process is within the range of the desired preset value of e.g. 100% quality. If the production status at that moment is outside the desired preset, the operator is subsequently able to control the production process accordingly.

In accordance with claim 4, the diverse test information can be reduced to a single piece of result-information by means of suitable evaluation methods.

In each case, it is possible to achieve the object of making it easier for the operator to supervise the current operating status during panel-production and thus to configure the production overall in a more reliable manner.

The object is also achieved by the features of claim 2. In each case, the signals for each ultrasonic receiver provided are combined, evaluated and reduced, whereby for each receiver, a single piece of result-information is obtained in each case. As the result-information, a characteristic number of quality can also be selected, and it is possible to perform the reduction by means of suitable evaluation methods. As in the case of the above-described embodiment of the invention, it is possible to provide a corresponding pointer. Furthermore, in accordance with claim 2, it is possible to provide both an evaluation system for all ultrasonic receivers as well as alternatively a separate evaluation system for each ultrasonic receiver. The aforementioned object is likewise achieved.

1. Method of testing a panel-like workpiece, e.g. a chip panel or a fibre panel, by means of ultrasonic penetration with at least one inspection channel,
wherein each inspection channel comprises an ultrasonic transmitter and an ultrasonic receiver which are separated from each other by means of an air gap,
wherein the workpiece is moved through the air gap,
and wherein an output of each ultrasonic receiver is connected to an evaluation system,
characterised in that in the evaluation system all of the diverse test signals and test information obtained from the at least one ultrasonic receiver are combined, evaluated and reduced to a single piece of result-information which describes the tested workpiece.

2. Method of testing a panel-like workpiece, e.g. a chip panel or a fibre panel, by means of ultrasonic penetration with at least two inspection channels,
wherein each inspection channel comprises an ultrasonic transmitter and an ultrasonic receiver which are separated from each other by means of an air gap,
wherein the workpiece is moved through the air gap,
and wherein an output of each ultrasonic receiver is connected to an evaluation system,
characterised in that in the evaluation system in each case for each ultrasonic receiver, all of the diverse test signals and test information obtained therefrom are combined, evaluated and reduced in each case to a single piece of result-information which describes the workpiece.

3. Method according to claim 1 or 2, characterised in that a characteristic number of quality is selected as the result-information.

4. Method according to any one of the preceding claims, characterised in that the reduction is performed by means of suitable evaluation methods.
